(19) United States
(12) Patent Application Publication
(10) Pub. No.: US 2003/0219982 A1
(43) Pub. Date: Nov. 27, 2003

(54) CMP (chemical mechanical polishing) polishing liquid for metal and polishing method

(75) Inventors: Yasushi Kurata, Ibaraki-ken (JP); Yasuo Kamigata, Ibaraki-ken (JP); Takeshi Uchida, Ibaraki-ken (JP); Hiroki Terazaki, Ibaraki-ken (JP); Akiko Igarashi, Ibaraki-ken (JP)

Correspondence Address: GREENBLUM & BERNSTEIN, P.L.C., 1950 ROLAND CLARKE PLACE, RESTON, VA, 20191, US

(73) Assignee: HITACHI CHEMICAL CO., LTD, Tokyo (JP)

(21) Appl. No.: 10/152,983

(22) Filed: May 23, 2002

(51) Int. Cl. C09G 1/02; C09G 1/04; B24B 1/00

(52) U.S. Cl. 438/692; 438/693; 106/3; 51/298; 51/307; 51/308; 51/309

(57) ABSTRACT

A polishing liquid for metal containing a metal-oxidizing agent, an oxidized metal dissolving agent, a protective film forming agent, a water-soluble polymer and water, the polishing liquid being used for producing a wiring pattern having a metal-embedded wiring portion of 10 to 100 μm width and an insulating portion of 10 to 100 μm width in which pattern the wiring portion is arranged at a wiring density of 40 to 60%, the polishing liquid for metal being comprising in that, when a surface to be polished of a metal film embedded in the wiring portion and a surface to be polished of an insulating film formed at both side portions of the metal film is polished substantially flush, wherein (width of the metal-embedded wiring portion)/(magnitude of dishing (depth)) is no less than 10³.

According to the present invention, there is provided a polishing liquid for metal which allows significant reduction of “dishing” at the relatively wide metal-wiring portion, as well as significantly reliable pattern formation of embedded metal film, as compared with the prior art.

### BACKGROUND OF THE INVENTION

1. Field of the Invention

The present invention relates to a polishing liquid for metal and a polishing method using the same, employed in a wiring process of a semiconductor device.

2. Description of the Related Art

In recent years, as a large scale integrated circuit (LSI) of a semiconductor advances to fulfil the demand of higher integration and performance, new microprocessing techniques have been developed. The Chemical Mechanical Polishing (CMP) method is one of the new microprocessing techniques, which is often used in a LSI production process, especially for flattening interlaminar insulating films, formation of a metal plug and embedded wires in a multi-layered wiring-formation process. This technique is disclosed in U.S. Pat. No. 4,944,836.

Additionally, in recent years, use of copper alloy as a wire material has been attempted in order to enhance the performance of LSI. However, in the case of copper alloy, it is difficult to perform microprocessing according to dry etching, which dry etching has been often used in the conventional method of forming aluminum alloy wiring. Therefore, there has been employed what is called Damascene method in which a thin film of copper alloy is accumulated on and embedded in an insulating film by way of a groove formed in advance at the insulating film and then the copper alloy thin film remaining at the portions other than the groove portion is removed by CMP, whereby embedded wiring is completed. This technique is disclosed in JP-A 2-278822 Laid-Open.

In general, a CMP method in metal processing includes the steps of: sticking a polishing pad on a disc-shaped polishing platen; soaking the surface of the polishing pad with a polishing liquid for metal; pressing, one surface of a substrate at which surface a metal film has been formed, against the surface of the polishing pad, with applying a predetermined pressure (a polishing pressure or a polishing load) thereon from the other or back surface of the substrate, and rotating the polishing platen in that state; and removing the projected portion of the metal film by utilizing mechanical friction between the polishing liquid and the projected portion of the metal film.

The polishing liquid for metal used for CMP generally contains an oxidizer and solid polishing particles. An oxidized metal dissolving agent and a protective film forming agent are further added thereto, according to necessity. With regards to the basic mechanism of CMP, it is assumed that at first the surface of the metal film is oxidized by oxidization and then the oxidized layer is scraped off by the solid polishing particles. The oxidized layer existing at the dented portion of the metal surface is hardly brought into contact with the polishing pad and thus the solid polishing particles do not have so much scraping effect thereon. In other words, the metal layer present at the projected portion of the substrate surface is removed as CMP is effected, whereby the substrate surface is made flat and smooth. The details of the feature described above is disclosed in Journal of Electrochemical Society, vol. 138, No. 11 (1991), pp. 3460-3464.

It has been known that addition of an oxidized metal dissolving agent is effective as a method of increasing the polishing rate by CMP. It is understood that addition of an oxidized metal dissolving agent is effective because the scraping effect by the solid polishing particles is enhanced by dissolving the particles of metal oxides, which have been scaraped off by the solid polishing particles, in the polishing liquid. However, if the oxidized layer existing at the dented portion of the metal film surface is also etched and the metal film surface is exposed, the metal film surface is further oxidized by the oxidizing agent. In a case in which such excessive etching is repeated, the metal film at the dented portion is considerably etched, whereby there arises a concern that the flattening effect by CMP is marred. In order to prevent such excessive etching from occurring, a protective film forming agent is added. That is, it is important of balance the effect of the oxidized metal dissolving agent and the effect of the protective film forming agent. It is preferable that the oxidized layer present at the dented portion of the metal film surface is not etched so much, the particles of the oxidized layer which have been scraped off are efficiently dissolved and the polishing rate by CMP is significantly large.

As described above, by further providing the effect of chemical reactions by adding an oxidized metal dissolving agent and a protective film forming agent, the CMP rate (the polishing rate by CMP) is effectively increased and the damage caused at the surface of the metal layer as a result of CMP is effectively reduced.

However, in a case in which embedded wiring is formed by CMP by using a polishing liquid for metal containing solid polishing particles of the conventional type, there arise such problems as follows: (1) occurrence of a phenomenon in which the center portion at the surface of the embedded metal wiring is isotropically etched, whereby the center portion is recessed like a dish (i.e., generation of “dishing”) and/or a phenomenon in which the insulating film is also polished at a portion having high wiring density, whereby the thickness of the metal wiring is reduced (i.e., generation of “erosion” or “thinning”); (2) generation of polishing scratch caused by the solid polishing particles; (3) the complicated washing process required for removing solid polishing particles remaining at the substrate surface after polishing; and (4) increase in cost due to the high cost of the solid polishing particles and the inevitalble treatment of waste liquid.

In order to suppress “dishing” and etching of copper alloy during polishing and form highly reliable LSI wiring, there has been proposed a method using a polishing liquid for metal containing: an oxidized metal dissolving agent composed of an amino acid (such as glycine) or amidosulfuric acid; and BTA (benzotriazol). This technique is disclosed, for example, in JP-A 8-83780.

In the Damascene wiring formation of copper or copper alloy or the metal-embedding formation such as plug wiring formation of tungsten or the like, if the polishing rate of the silicon dioxide film as the interlaminar insulating film formed at the portion other than the embedded portion is also large, there arises the phenomenon of “erosion” in which reduction of wiring thickness and reduction of thickness of the interlaminar insulating film simultaneously occur. As a result, since there is generated variation in resistance due to the increase in the wiring resistance, the pattern density or the like, a characteristic that the polishing rate of the silicon dioxide film is sufficiently smaller than the polishing rate of the metal film to be polished is required. Therefore, there has been proposed a method in which pH of the polishing liquid is made higher than pKa −0.5 by suppressing the polishing rate of silicon dioxide by the action of an anion produced as a result of dissociation of an acid. This technique is disclosed, for example, in JP-B 2819196.

As a lower layer beneath copper or copper alloy of wiring, a barrier layer of a substance selected from the group consisting of tantalum, tantalum alloy, tantalum nitride and tantalum compounds of other types is formed in order to prevent copper from diffusing into the interlaminar insulating film. Accordingly, at the portion other than the wiring portion at which copper or copper alloy is to be embedded, the exposed barrier layer must be removed by CMP. However, as the barrier layer conductor film is harder than copper or copper alloy, a sufficiently high CMP rate is hardly obtained, normally, if a combination of the polishing materials for copper or copper alloy is simply employed. An attempt to continually polish the barrier layer with such a polishing liquid would result in generation of “dishing” at the copper (or copper alloy) portion. Therefore, there has been studied a two-stage polishing method including the first step of polishing copper or copper alloy and the second step of polishing the barrier layer conductor.

In the aforementioned two-stage polishing method including the first step of polishing copper or copper alloy and the second step of polishing the barrier layer, as the hardness and the chemical characteristics of the films to be polished are significantly different between the two steps, and as the polishing rate at copper or copper alloy must differ from the polishing rate at the barrier layer, pH of the polishing liquid and the compositions of the polishing particles, the additives and the like are made significantly different between the two steps, according to the study.

In order to form embedded wiring having excellent electric characteristic in which little “dishing” or “erosion” is exhibited, the polishing rate of the metal such as copper alloy must be significantly large, as compared with the etching rate at which the metal is etched. Due to this, a polishing liquid containing solid polishing particles and having an excellent mechanical polishing effect has been employed. However, in the case of a polishing liquid having an excellent mechanical polishing effect as described above, (1) the solid polishing particles have an effect on the dented portion of the pattern, as well, whereby the dented portion of the pattern is significantly polished and “dishing” is eventually caused, and (2) at the portion having high wiring density, the narrow, projected portion of the pattern is polished as the wiring metal film is polished, whereby “erosion” is eventually caused.

Further, in order to remove the metal film at the portions other than the wiring portion, of the entire surface of the polished substrate, it is necessary to select the polishing time which is required at the portion where the polishing rate is slowest. As a result, the portion where polishing proceeds relatively fast is inevitably subjected to over-polishing, and “dishing” and/or “erosion” significantly increases in such over-polished portion, causing a problem to be solved.

In short, a polishing liquid for metal having a characteristic, that the magnitude of “dishing” at a relatively wide metal wiring portion is smaller than that of the prior art and “dishing” is not so much increased at the time of “over-polishing” as is in the prior art, has been in demand. Additionally, a polishing liquid for metal having a characteristic, that the magnitude of “erosion” at a metal wiring portion having a relatively high wiring density is smaller than that of the prior art and “erosion” is not so much increased at the time of “over-polishing” as is in the prior art, has been on demand.

### SUMMARY OF THE INVENTION

As described above, the present invention relates to a polishing liquid for metal which can significantly reduce “dishing” generated at a relatively wide metal wiring portion, as compared with the prior art, and allow a more reliable pattern formation of embedded metal film. The present invention also relates to a polishing method using the polishing liquid for metal described above.

Specifically, a polishing liquid for metal according to a first aspect of the present invention is a polishing liquid for metal containing a metal-oxidizing agent, an oxidized metal dissolving agent, a protective film forming agent, a water-soluble polymer and water, characterized in that, in a pattern in which a metal-embedded wiring having width of 100 μm and an insulating film having width of 100 μm are to be alternately formed or in a pattern in which a metal-embedded wiring having width of 10-100 μm and an insulating film having width of 10-100 μm are to be alternately formed, when a metal film formed as a film to be embedded in the wiring portion is polished such that the metal film present above the insulation film is removed, the magnitude or depth of recess (the magnitude of “dishing”) determined on the basis of the bottom point of the recess and the two points as the intersections of the curve of the recess and the insulating film layers as the two ends of the wiring-portion metal is no larger than 100 nm.

And/or, a polishing liquid for metal according to the first aspect of the present invention is a polishing liquid for metal containing a metal-oxidizing agent, an oxidized metal dissolving agent, a protective film forming agent, a water-soluble polymer and water, characterized in that, in a pattern in which a metal-embedded wiring having width of 100 μm and an insulating film having width of 100 μm are to be alternately formed or in a pattern in which a metal-embedded wiring having width of 10-100 μm and an insulating film having width of 10-100 μm are to be alternately formed, when the wiring-portion metal is polished for a period of time which is 1.5 times as long as the time (counted from the start of polishing) required for a metal film formed as a film to be embedded in the wiring portion is polished such that the metal film present above the insulation film is removed, i.e., when 50% over-polishing, as compared with the targeted polishing, is carried out, the magnitude or depth of recess (the magnitude of “dishing”) determined on the basis of the bottom point of the recess and the two points as the intersections of the curve of the recess and the insulating film layers as the two ends of the wiring-portion metal increases by no larger than 50 nm, as compared with the magnitude of dishing when polishing is effected for the targeted polishing time.

Further, the polishing liquid for metal according to the first aspect of the present invention is characterized in that, in a pattern in which a metal-embedded wiring having width of 100 μm and an insulating film having width of 100 μm are to be alternately formed or in a pattern in which a metal-embedded wiring having width of 10 to 100 μm and an insulating film having width of 10 to 100 μm are to be alternately formed, when a metal film formed as a film to be embedded in the wiring portion is polished such that the metal film present above the insulation film is removed, the magnitude or depth of recess (the magnitude of “dishing”) determined on the basis of the bottom point of the recess and the two points as the intersections of the curve of the recess and the insulating film layers as the two ends of the wiring-portion metal is no larger than 50 nm.

Yet further, the polishing liquid for metal according to the first aspect of the present invention is characterized in that, in a pattern in which a metal-embedded wiring having width of 100 μm and an insulating film having width of 100 μm are to be alternately formed or in a pattern in which a metal-embedded wiring having width of 10 to 100 μm and an insulating film having width of 10 to 100 μm are to be alternately formed, when the wiring-portion metal is polished for a period of time which is 1.5 times as long as the time (counted from the start of polishing) required for a metal film formed as a film to be embedded in the wiring portion is polished such that the metal film present above the insulation film is removed, i.e., when 50% over-polishing, as compared with the targeted polishing, is carried out, the magnitude or depth of recess (the magnitude of “dishing”) determined on the basis of the bottom point of the recess and the two points as the intersections of the curve of the recess and the insulating film layers as the two ends of the wiring-portion metal increases by no larger than 30 nm, as compared with the magnitude of dishing when polishing is effected for the targeted polishing time.

By the process, in which the polishing liquid for metal of the first aspect of the present invention is used, of polishing a metal film comprising laminated films including a metal layer of at least one type of substance selected from the group consisting of copper, copper alloy and oxides thereof, at least a portion of the metal film can be removed. By the process, in which the polishing liquid for metal of the first aspect of the present invention is used, of polishing a metal film comprising laminated films including a metal barrier of at least one type of substance selected from the group consisting of tantalum, tantalum nitride, tantalum alloy and tantalum compounds of other types, at least a portion of the metal film can be removed. In the polishing method using the polishing liquid of the present invention, a film to be polished, of a substrate, can be polished by moving a polishing platen relative to the substrate in the state in which the film to be polished of the substrate is pressed against a polishing pad stacked on the polishing platen, while the polishing liquid for metal of claim 1 is supplied to the polishing pad.

According to the first aspect of the present invention, by combining a protective film forming agent with a water-soluble polymer, there is provided a polishing liquid for metal which exhibits a characteristically small amount of “dishing” at a relatively wide metal wiring portion and a characteristically small increase in “dishing” at the time of over-polishing.

That is, according to the first aspect of the present invention, there is provided a polishing liquid for metal which allows significant reduction of “dishing” at the relatively wide metal-wiring portion, as well as significantly reliable pattern formation of embedded metal film, as compared with the prior art. The first aspect of the present invention also provides a polishing method using this polishing liquid for metal.

Specifically, in a pattern in which a metal-embedded wiring having width of 100 μm and an insulating film having width of 100 μm are to be alternately formed or in a pattern in which a metal-embedded wiring having width of 10 to 100 μm and an insulating film having width of 10 to 100 μm are to be alternately formed, when a metal film formed as a film to be embedded in the wiring portion is polished such that the metal film present above the insulation film is removed, if the magnitude or depth of recess (the magnitude of “dishing”) determined on the basis of the bottom point of the recess and the two points as the intersections of the curve of the recess and the insulating film layers as the two ends of the wiring-portion metal is no larger than 100 nm, the generally-formed wiring having width of no larger than 100 μm can obtain an excellent electric property in which no increase in the wiring resistance due to “dishing” is observed, as a result of polishing the second barrier layer with an appropriate polishing liquid. In this case, it is more preferable that the magnitude of “dishing” is no larger than 50 nm. In a pattern in which a metal-embedded wiring having width of 100 μm and an insulating film having width of 100 μm are to be alternately formed or in a pattern in which a metal-embedded wiring having width of 10 to 100 μm and an insulating film having width of 10 to 100 μm are to be alternately formed, when the wiring-portion metal is polished for a period of time which is 1.5 times as long as the time (counted from the start of polishing) required for a metal film formed as a film to be embedded in the wiring portion is polished such that the metal film present above the insulation film is removed, i.e., when 50% over-polishing, as compared with the targeted polishing, is carried out, if the magnitude or depth of recess (the magnitude of “dishing”) determined on the basis of the bottom point of the recess and the two points as the intersections of the curve of the recess and the insulating film layers as the two ends of the wiring-portion metal increases by no larger than 50 nm, as compared with the magnitude of dishing when polishing is effected for the targeted polishing time, an excellent electric property in which no increase in the wiring resistance due to “dishing” is observed can be obtained by polishing the second barrier layer with an appropriate polishing liquid. In this case, it is preferable that the increase in the magnitude of “dishing” is no larger than 30 nm.

Further, the present invention relates to a polishing liquid for metal which can significantly reduce “erosion” at a metal wiring portion having high wiring density, as compared with the prior art, and allow a more reliable pattern formation of embedded metal film. The present invention also relates to a polishing method using the polishing liquid for metal described above.

Specifically, a polishing liquid for metal according to a second aspect of the present invention is a polishing liquid for metal containing a metal-oxidizing agent, an oxidized metal dissolving agent, a protective film forming agent, a water-soluble polymer and water, characterized in that, in a pattern in which a metal-embedded wiring having width of 4.5 μm and an insulating film having width of 0.5 μm are to be alternately formed and whose wiring pattern density is to be 70% or higher or in a pattern in which a metal-embedded wiring having width of 1 to 10 μm and an insulating film having width of 0.1 to 1 μm are to be alternately formed and whose wiring pattern density is to be 70% or higher, when a metal film formed as a film to be embedded in the wiring portion is polished such that the metal film present above the insulation film in the vicinity of the pattern is removed, the magnitude or depth of recess (the magnitude of “erosion”) determined on the basis of the bottom point of the recess and the two points as the intersections of the curve of the recess and the insulating film layers in the vicinity of the insulating film portion is no larger than 80 nm.

And/or a polishing liquid for metal according to a second aspect of the present invention is a polishing liquid for metal containing a metal-oxidizing agent, an oxidized metal dissolving agent, a protective film forming agent, a water-soluble polymer and water, characterized in that, in a pattern in which a metal-embedded wiring having width of 4.5 μm and an insulating film having width of 0.5 μm are to be alternately formed and whose wiring pattern density is to be 70% or higher or in a pattern in which a metal-embedded wiring having width of 1 to 10 μm and an insulating film having width of 0.1 to 1 μm are to be alternately formed and whose wiring pattern density is to be 70% or higher, when the wiring-portion metal is polished for a period of time which is 1.5 times as long as the time (counted from the start of polishing) required for a metal film formed as a film to be embedded in the wiring portion is polished such that the metal film present above the insulation film in the vicinity of the pattern is removed, i.e., when 50% over-polishing, as compared with the targeted polishing, is carried out, the magnitude or depth of recess (the magnitude of “erosion”) determined on the basis of the bottom point of the recess and the two points as the intersections of the curve of the recess and the insulating film layers in the vicinity of the insulating film portion increases by no larger than 40 nm, as compared with the magnitude of erosion when polishing is effected for the targeted polishing time.

Further, the polishing liquid for metal according to the second aspect of the present invention is characterized in that, in a pattern in which a metal-embedded wiring having width of 4.5 μm and an insulating film having width of 0.5 μm are to be alternately formed and whose wiring pattern density is to be 70% or higher or in a pattern in which a metal-embedded wiring having width of 1 to 10 μm and an insulating film having width of 0.1 to 1 μm are to be alternately formed and whose wiring pattern density is to be 70% or higher, when a metal film formed as a film to be embedded in the wiring portion is polished such that the metal film present above the insulation film in the vicinity of the pattern is removed, the magnitude or depth of recess (the magnitude of “erosion”) determined on the basis of the bottom point of the recess and the two points as the intersections of the curve of the recess and the insulating film layers in the vicinity of the insulating film portion is no larger than 40 nm.

Yet further, the polishing liquid for metal according to the second aspect of the present invention is characterized in that, in a pattern in which a metal-embedded wiring having width of 4.5 μm and an insulating film having width of 0.5 μm are to be alternately formed and whose wiring pattern density is to be 70% or higher or in a pattern in which a metal-embedded wiring having width of 1-10 μm and an insulating film having width of 0.1-1 μm are to be alternately formed and whose wiring pattern density is to be 70% or higher, when the wiring-portion metal is polished for a period of time which is 1.5 times as long as the time (counted from the start of polishing) required for a metal film formed as a film to be embedded in the wiring portion is polished such that the metal film present above the insulation film in the vicinity of the pattern is removed, i.e., when 50% over-polishing, as compared with the targeted polishing, is carried out, the magnitude or depth of recess (the magnitude of “erosion”) determined on the basis of the bottom point of the recess and the two points as the intersections of the curve of the recess and the insulating film layers in the vicinity of the insulating film portion increases by no larger than 25 nm, as compared with the magnitude of erosion when polishing is effected for the targeted polishing time.

By the process, in which the polishing liquid for metal of the second aspect of the present invention is used, of polishing a metal film comprising laminated films including a metal layer of at least one type of substance selected from the group consisting of copper, copper alloy and oxides thereof, at least a portion of the metal film can be removed. By the process, in which the polishing liquid for metal of the second aspect of the present invention is used, of polishing a metal film comprising laminated films including a metal barrier layer of at least one type of substance selected from the group consisting of tantalum, tantalum nitride, tantalum alloy and tantalum compounds of other types, at least a portion of the metal film can be removed. In the polishing method using the polishing liquid of the present invention, a film to be polished, of a substrate, is polished by moving a polishing platen relative to the substrate in the state in which the film to be polished of the substrate is pressed against a polishing pad stacked on the polishing platen, while the polishing liquid for metal of claim 1 is supplied to the polishing pad.

That is, according to the second aspect of the present invention, there is provided a polishing liquid for metal which allows significant reduction of “erosion” at the metal wiring portion having considerably high wiring density, as well as significantly reliable pattern formation of embedded metal film, as compared with the prior art. The second aspect of the present invention also provides a polishing method using this polishing liquid for metal.

Specifically, in the case of the polishing liquid for metal of the second aspect of the present invention, in a pattern in which a metal-embedded wiring having width of 4.5 μm and an insulating film having width of 0.5 μm are to be alternately formed and whose wiring pattern density is to be 70% or higher or in a pattern in which a metal-embedded wiring having width of 1 to 10 μm and an insulating film having width of 0.1 to 1 μm are to be alternately formed and whose wiring pattern density is to be 70% or higher, when a metal film formed as a film to be embedded in the wiring portion is polished such that the metal film present above the insulation film in the vicinity of the pattern is removed, if the magnitude or depth of recess (the magnitude of “erosion”) determined on the basis of the bottom point of the recess and the two points as the intersections of the curve of the recess and the insulating film layers in the vicinity of the insulating film portion is no larger than 80 nm, the generally-formed wiring having wiring density of 70% or less can obtain an excellent electric property in which no increase in the wiring resistance due to “erosion” is observed, as a result of polishing the second barrier layer with an appropriate polishing liquid. In this case, it is more preferable that the magnitude of “erosion” is no larger than 40 nm. In a pattern in which a metal-embedded wiring having width of 4.5 μm and an insulating film having width of 0.5 μm are to be alternately formed and whose wiring pattern density is to be 70% or higher or in a pattern in which a metal-embedded wiring having width of 1 to 10 μm and an insulating film having width of 0.1 to 1 μm are to be alternately formed and whose wiring pattern density is to be 70% or higher, when the wiring-portion metal is polished for a period of time which is 1.5 times as long as the time (counted from the start of polishing) required for a metal film formed as a film to be embedded in the wiring portion is polished such that the metal film present above the insulation film in the vicinity of the pattern is removed, i.e., when 50% over-polishing, as compared with the targeted polishing, is carried out, the magnitude or depth of recess (the magnitude of “erosion”) determined on the basis of the bottom point of the recess and the two points as the intersections of the curve of the recess and the insulating film layers in the vicinity of the insulating film portion increases by no larger than 40 nm, as compared with the magnitude of erosion when polishing is effected for the targeted polishing time. In this case, it is preferable that the increase in the magnitude of “erosion” is no larger than 25 nm.

### DETAILED DESCRIPTION OF THE INVENTION

As the protective film forming agent contained in the polishing liquid for metal, a compound which is easily reacted with copper, to form a chelate complex, has conventionally been used. Examples of such compound include some nitrogen-containing compounds such as ethylenediaminetetraacetic acid, benzotriazole and the like.

However, as the protective film forming agent as described above has an extremely strong effect of forming a protective film on a metal surface, if the content of the protective film forming agent in the polishing liquid for metal is equal to or exceeds 0.5 weight %, the copper alloy is no longer etched and even CMP is disturbed. Therefore, an operator (i.e., one skilled in the art) has to very carefully adjust the content of the nitrogen-containing compound in the polishing liquid for metal and/or increase the rate of etching.

The inventors of the present invention have discovered, as a result of keen study for realizing a polishing liquid for metal having the most preferable characteristics, that use of a protective film forming agent in combination with a water-soluble polymer allows high a CMP rate, while the etching rate at a metal layer such as copper alloy is suppressed sufficiently low. Further, the inventors of the present invention have discovered that, by using such polishing liquid as described above, polishing at a practically-acceptable CMP rate can be effected without including the solid polishing particles in the polishing liquid. The excellent CMP performance is achieved without the help of the solid polishing particles, probably because the friction or abrasion caused by the polishing pad results in an excellent scraping-off effect which well replaces the scraping-off effect of the solid polishing particles of the prior art.

According to the present invention which has been achieved on the basis of the discoveries described above, as the friction between the polishing pad and the dented portion of the pattern, during the scraping-off process effected by the friction or abrasion caused by the polishing pad, is very little, the dented portion of the pattern is hardly polished. Therefore, there is obtained the unique characteristic that the magnitudes of “dishing”, “erosion”, the increases in “dishing” and “erosion” at the time of over-polishing, are all significantly small.

In the present invention, a metal film containing copper, copper alloy (copper/chrome or the like) is formed/charged on a substrate surface at which a dented portion has been formed. When this substrate is subjected to CMP by using the polishing liquid for metal of the present invention, the metal film present at the projected portion of the substrate is selectively subjected to CMP, whereby a desirable conductor pattern in which the metal film is remained only at the dented portion is obtained.

In the polishing liquid for metal of the present invention, it is substantially unnecessary to add the solid polishing particles thereto and CMP is effected by the friction between the substrate and the polishing pad which is far softer, in mechanical terms, than the solid polishing particles. Therefore, according to the polishing liquid for metal of the first aspect of the present invention, the dented portion of the pattern is hardly polished, whereby the characteristic that the magnitude of “dishing” and the increase in “dishing” at the time of over-polishing are significantly small is obtained and the polishing scratches are drastically reduced. Additionally, according to the polishing liquid for metal of the second aspect of the present invention, the barrier layer and the insulating film layer between the metal wiring are hardly polished, whereby the characteristic that the magnitude of “erosion” and the increase in “erosion” at the time of over-polishing are significantly small, is obtained and the polishing scratches are dramatically reduced.

The polishing liquid for metal of the present invention essentially contains an oxidizing agent, an oxidized metal dissolving agent, a protective film forming agent, a water-soluble polymer and water. It is acceptable that the polishing liquid for metal of the present invention contains substantially no solid polishing particles.

Examples of the metal-oxidizing agent include hydrogen peroxide (H₂O₂), nitric acid, potassium periodate, hypochlorous acid and ozone (aq). Among these examples, hydrogen peroxide is especially preferable. In the case in which the substrate is a silicon substrate containing an element for a integrated circuit, an oxidizing agent which does not contain nonvolatile components is preferable, so that undesirable pollution caused by alkali metal, alkali earth metal, halides or the like can be avoided. Ozone (aq) exhibits rapid change in the composition thereof in a period of time. Accordingly, hydrogen peroxide is the most preferable as the oxidizing agent. However, if the substrate to be polished does not contain a semiconductor element (e.g., a glass substrate), an oxidizing agent containing nonvolatile components may also be acceptable.

The oxidized metal dissolving agent is preferably water-soluble and contains at least one type of compound selected from the group consisting of an organic acid, an organic acid ester, an ammonium salt of an organic acid, and sulfuric acid. Above all, an aqueous solution of a substance selected from the group consisting of the following substances is especially preferable: formic acid, acetic acid, propionic acid, butyric acid, valerianic acid, 2-methyl butyric acid, n-hexanoic acid, 3,3-dimethyl butyric acid, 2-ethyl butyric acid, 4-methyl pentanoic acid, n-heptanoic acid, 2-methyl hexanoic acid, n-octanoic acid, 2-ethyl hexanoic acid, benzoic acid, glycollic acid, salicylic acid, glyceric acid, oxalic acid, malonic acid, succinic acid, glutaric acid, adipic acid, pimelic acid, maleic acid, phthalic acid, malic acid, tartaric acid, citric acid, a salt (such as an ammonium salt) of the aforementioned organic acid, sulfuric acid, nitric acid, ammonia, an ammonium salt such as potassium persulfate, ammonium nitrate, ammonium chloride, chromic acid, and amixture of thereof. Among these examples, formic acid, malonic acid, malic acid, tartaric acid and citric acid are preferably used for a laminate film including a metal layer of at least one type of substance selected from the group consisting of copper, copper alloy and an oxide of copper or copper alloy. The aforementioned organic acids are preferable because the acids allow easy balancing of effects between themselves and the protective film forming agent. Malic acid, tartaric acid and citric acid are especially preferable because the acids allow effective suppression of the etching rate, with maintaining a high, practically acceptable CMP rate.

As the protective film forming agent, those which form a protective film on a metal surface is preferable. The protective film forming agent is preferably at least one type of compound selected from the group consisting of a nitrogen-containing compound and a salt thereof, mercaptan, glucose and cellulose. Above all, at least one type of compound selected from the group consisting of the following substances is especially preferable: ammonia; alkyl amine such as dimethyl amine, trimethyl amine, triethyl amine, propylenediamine; amine such as ethylene diamine tetraacetic acid (EDTA), sodium diethyl dithiocarbamate and chitosan; amino acid such as glycine, L-alanine, β-alanine, L-2-aminobutyric acid, L-norvaline, L-valine, L-leucine, L- norleucine, L-isoleucine, L-alloisoleucine, L-phenylalnine, L-proline, sarcosine, L-ornithine, L-lysine, taurine, L-serine, L-threonine, L-allothreonine, L-homoserine, L-tyrosine, 3,5-diiodo-L-tyrosine, β-(3,4-dihydroxyphenyl)-L-alanine, L-thyroxine, 4-hydroxy-L-proline, L-cysteine, L-methionine, L-ethionine, L-lanthionine, L-cystathionine, L-cystine, L-cysteic acid, L-aspartic acid, L-glutamic acid, S-(carboxymethyl)-L-cysteine, 4-aminobutyric acid, L-asparagine, L-glutamine, azaserine, L-arginine, L-canavanine, L-citrulline, δ-hydroxy-L-lysine, creatine, L-kynurenine, L-histidine, 1-methyl-L-histidine, 3-methyl-L-histidine, ergothioneine, L-tryptophan, actinomycin Cl, apamine, angiotensin I, angiotensin II and antipaine; imine such as dithizone, cuproin (2,2′-bequinoline), neocuproin(2,9-dimethyl-1,10-phenanthroline), bathocuproin(2,9-dimethyl-4,7-diphenyl-1,10-phenanthrolin e) and cuperazon (bis-cyclohexanoneoxalyl hydrazone); azole such as benzimidazole-2-thiol, 2-[2-(benzothiazolyl)]thiopropionic acid, 2-[2-(benzothiazolyl)]thiobutyric acid, 2-mercaptobenzotiazole, 1,2,3-triazole, 1,2,4-triazole, 3-amino-1H-1,2,4-triazole, benzotriazole, 1-hydroxybenzotriazole, 1-dihydroxypropylbenzotriazole, 2,3-dicarboxypropylbenzotriazole, 4-hydroxybenzotriazole, 4-carboxyl-1H-benzotriazole, 4-methoxycarbonyl-1H-benzotriazole, 4-butoxycarbonyl-1H-benzotriazole, 4-octyloxycarbonyl-1H-benzotriazole, 5-hexylbenzotriazole, N-(1,2,3-benzotriazolyl-1-methyl)-N-(1,2,4-triazolyl-1-me thyl)-2-ethylhexylamine, tolyltriazole, naphthotriazole, bis[(1-benzotriazolyl)methyl]phosphate; mercaptan such as nonylmercaptan, dodecylmercaptan, triazinethiol, triazinedithiol, triazinetrithiol; and saccharides such as glucose and cellulose. Among these examples, chitosan, ethylene diamine tetraacetic acid, L-tryptophan, cuperazon, triazinethiozole, benzotriazole, 4-hydroxybenzotriazole, 4-carboxylbenzotriazolebutyl ester, tolyltriazole, naphthotriazole are preferable, in terms of making a high CMP rate compatible with a low etching rate.

The water-soluble polymer is preferably at least one type of substance selected from the group consisting of polysaccharide, polycarboxylic acid, an ester of polycarboxylic acid, a salt of polycarboxylic acid and vinyl-based polymer. Above all, especially preferable is at least one type of substance selected from the group consisting of the following compounds: polysaccharides such as alginic acid, pectic acid, carboxymethyl cellulose, agar, curdlan and pullulan; a salt of amino acid such as ammonium salt of glycine and sodium salt of glycine; polycarboxylic acid such as polyaspartic acid, polyglutamic acid, polylysine, poymalic acid, polymethacrylic acid, ammonium salt of polymethacrylic acid, sodium salt of polymethacrylic acid, polymaleic acid, polyitaconic acid, polyfumaric acid, poly(p-styrenecarboxylic acid), polyacrylic acid, polyacrylamide, aminopolyacrylamide, ammonium salt of polyacrylic acid, sodium salt of polyacrylic acid, polyamic acid, ammonium salt of polyamic acid, sodium salt of polyamic acid, polyglyoxylic acid, and a salt of the aforementioned polycarboxylic acid; and vinyl-based polymer such as polyvinyl alcohol, polyvinyl pyrrolidone and polyacrolein. In the case in which the substrate is a silicon substrate for a semiconductor integrated circuit, a water-soluble polymer is preferably an acid or an ammonium salt thereof, so that undesirable pollution caused by alkali metal, alkali earth metal, halides or the like can be avoided. However, if a glass substrate or the like is used, such restriction as described above is unnecessary. Among the examples, especially preferable are pectic acid, agar, polymalic acid, polymethacrylic acid, an ammonium salt of polyacrylic acid, polyacrylamide, polyvinyl alcohol, polyvinyl pyrrolidone, and ester and ammonium salt thereof.

In the present invention, the content of a metal-oxidizing agent is preferably 0.003 to 0.7 mol, more preferably 0.03 to 0.5 mol and especially preferably 0.2 to 0.3 mol, with respect to the total weight (100 g) of the polishing liquid containing the metal-oxidizing agent, an oxidized metal dissolving agent, a protective film forming agent, water-soluble polymer and water. When the content of the metal-oxidizing agent is less than 0.003 mol, the metal is not sufficiently oxidized and the resulting CMP rate is low. When the content of the metal-oxidizing agent exceeds 0.7 mol, the polished surface tends to exhibit roughness.

The content of an oxidized metal dissolving agent is preferably 0.00001 to 0.005 mol, more preferably 0.00005 to 0.0025 mol and especially preferably 0.0005 to 0.0015 mol, with respect to the total weight (100 g) of the polishing liquid containing a metal-oxidizing agent, the oxidized metal dissolving agent, a protective film forming agent, water-soluble polymer and water. When the content of the oxidized metal dissolving agent exceeds 0.005 mol, suppression of etching is likely to be difficult.

In the present invention, the content of a protective film forming agent is preferably 0.0001 to 0.05 mol, more preferably 0.0003 to 0.005 mol and especially preferably 0.0005 to 0.0035 mol, with respect to the total weight (100 g) of the polishing liquid containing a metal-oxidizing agent, an oxidized metal dissolving agent, the protective film forming agent, water-soluble polymer and water. When the content of the protective film forming agent is less than 0.0001 mol, suppression of etching may not be smoothly carried out. When the content of the protective film forming agent exceeds 0.05 mol, the CMP rate tends to be decreased.

In the present invention, the content of a water-soluble polymer is preferably 0.001 to 0.3 weight %, more preferably 0.003 to 0.1 weight % and especially preferably 0.01 to 0.08 weight %, with respect to the total weight (100 g) of the polishing liquid containing a metal-oxidizing agent, an oxidized metal dissolving agent, a protective film forming agent, the water-soluble polymer and water. When the content of the water-soluble polymer is less than 0.001 weight %, the etching-suppression effect of the water-soluble polymer, which is achieved by the use thereof in combination with the protective film forming agent, may not be sufficiently exhibited. On the other hand, when the content of the water-soluble polymer exceeds 0.3 weight %, the CMP rate tends to be decreased. The weight average molecular weight of the water-soluble polymer is preferably no less than 500, more preferably no less than 1500, and furthermore preferably no less than 5000. The upper limit of the weight average molecular weight is preferably no more than 5 million, in terms of maintaining excellent solubility, although there is no particular restriction on the upper limit of the weight average molecular weight of the polymer. When the weight average molecular weight is less than 500, a sufficiently high CMP rate is less likely to be achieved. In the present invention, it is preferable that at least one type of water-soluble polymer having weight average molecular weight of 500 or more is used.

The metal film to which the present invention is applied is preferably a laminate film including at least one type of substance selected from the group consisting of copper, copper alloy and oxides copper or copper alloy (which substance will occasionally be referred to as “copper alloy” hereinafter).

The metal film to which the present invention is applied is preferably a laminate film including a metal barrier layer of at least one type of substance selected from the group consisting of tantalum, tantalum nitride, tantalum alloy and tantalum compounds of other types.

The polishing method of the present invention is a polishing method in which a film to be polished, of a substrate, is polished by moving a polishing platen relative to the substrate in the state in which the film to be polished of the substrate is pressed against a polishing pad stacked on the polishing platen, while the aforementioned polishing liquid for metal is supplied to the polishing pad. As the polishing device, a generally-used polishing device which includes a holder for holding a semiconductor substrate and a platen having a polishing pad stacked thereon (and also having a motor or the like mounted thereon whose speed of rotation is adjustable) can be used. The material of the polishing pad is not particularly restricted, and common nonwoven fabric, foamed polyurethane, porous fluororesin and the like can be used as the polishing pad. Although there is no particular restriction on the polishing method, the rotational speed of the platen is preferably kept low (no higher than 200 rpm), so that the substrate does not come off. The pressure at which the film to be polished, of the substrate, is pressed against the polishing pad is preferably 9.8 to 98 Kpa (100 to 1000 gf/cm²) and, in order to achieve the unvaried, constant CMP rate and pattern-flatness at the entire wafer surface in the satisfactory manner, is more preferably 9.8 to 49 Kpa (100 to 500 gf/cm²). The polishing liquid for metal is continually supplied to the polishing pad by a pump or the like throughout the polishing process. Although there is no restriction on the amount, to be supplied, of the polishing liquid for metal, it is preferable that the surface of the polishing pad is constantly covered with the polishing liquid for metal. When the polishing of the semiconductor substrate is completed, the substrate is thoroughly washed with flowing water, having water drops attached thereon removed by spin dry or the like, and dried.

In the present invention, CMP can be evenly carried at an entire surface of a metal film of copper alloy or the like, without using solid polishing particles, by utilizing friction between the metal film and a polishing pad. Therefore, as the first aspect of the present invention, there can be provided a polishing liquid for metal having a characteristic that the magnitude of “dishing” and the increase in “dishing” at the time of over-polishing is insignificant and, as the second aspect of the present invention, there can be provided a polishing liquid for metal having a characteristic that the magnitude of “erosion” and the increase in “erosion” at the time of over-polishing is insignificant. Further, as the barrier layer and the insulating film layer function as a stopper at the first stage of polishing of copper alloy or the like in the two-stage polishing process, polishing in which the polishing time can be easily controlled and properties exhibit excellent “evenness” at the entire portion of the polished surface can be realized. As a result, it is possible to reduce variation in the electric properties due to the decrease in the wiring thickness caused by “dishing” or “erosion”. Further, since the polishing liquid for metal does not contain solid polishing particles, polishing scratches are drastically reduced. In the polishing liquid for metal of the present invention, it is assumed that, as the protective film forming agent is used in combination with the water-soluble polymer, the protective film forming agent well suppresses etching but fails to function as a metal surface protective film with respect to the friction caused by the polishing pad, thereby allowing a sufficiently high CMP rate. In CMP in general, the degree of occurrence of polishing scratches presumably depends on the particle diameter, the distribution of the particle diameter and the shape of the particles, of the solid polishing particles. The decrease in film thickness (erosion) due to scraping of the insulating film and the deterioration of the flattening effect also presumably depend on the particles diameter of the solid polishing particles and the physical properties of the polishing pad. In the case in which a metal film (a copper film, especially) surface is treated with benzotriazole (BTA), “dishing” of the metal film presumably depends on the hardness of the polishing pad and the chemical characteristics of the polishing liquid. In short, although the solid polishing particles, which are quite hard, have been necessitated for effecting CMP, the presence thereof is not desirable in terms of improving the flattening effect of CMP and making the CMP-processed surface more perfect (here, “being perfect” means that there is no polishing scratch or the like at the polished surface). It is understood that the flattening effect actually depends on the characteristic of the soft polishing pad rather than the solid polishing particles. From this point of view, it is apparent that the present invention which effects CMP in the sufficient manner without the help of the solid polishing particles is extremely preferable, for the CMP of copper alloy and thus for the formation of embedded pattern by CMP.

In addition to the aspects of the present invention as described above, the present invention further provides the following aspects.

Specifically, the present invention further provides a polishing liquid for metal containing a metal-oxidizing agent, an oxidized metal dissolving agent, a protective film forming agent, a water-soluble polymer and water, the polishing liquid being used for producing a wiring pattern having a metal-embedded wiring portion of 10 to 100 μm width and an insulating portion of 10 to 100 μm width in which pattern the wiring portion is arranged at a wiring density of 40 to 60%, the polishing liquid for metal being comprising in that, when a surface to be polished of a metal film embedded in the wiring portion and a surface to be polished of an insulating film formed at both side portions of the metal film is polished substantially flush, wherein (width of the metal-embedded wiring portion)/(magnitude of dishing (depth)) is no less than 10³. Here, it is preferable that the width of the metal-embedded wiring portion is 100 μm and the magnitude (depth) of “dishing” is no larger than 100 nm. It is preferable that (width of the metal-embedded wiring portion)/(magnitude of dishing (depth)) is no less than 2×10³. This polishing liquid for metal of the present invention is preferably used for a wiring pattern in which the wiring density at the wiring portion is 40 to 60% and each wiring is arranged with a constant interval therebeween.

The present invention further provides a polishing liquid for metal containing a metal-oxidizing agent, an oxidized metal dissolving agent, a protective film forming agent, a water-soluble polymer and water, the polishing liquid being used for producing a wiring pattern having a metal-embedded wiring portion of 10 to 100 μm width and an insulating portion of 10 to 100 μm width in which pattern the wiring portion is arranged at a wiring density of 40 to 60%, the polishing liquid for metal being comprising in that, when a surface to be polished of a metal film embedded in the wiring portion and a surface to be polished of an insulating film formed at both side portions of the metal film is polished substantially flush, wherein (width of the metal-embedded wiring portion)/(magnitude of dishing (depth)) is no less than 2×10³ at the time of effecting polishing 1.5 times as long as the time required for standard polishing (i.e. at the time of effecting 50% over-polishing). Here, it is preferable that the width of the metal-embedded wiring portion is 100 μm and the magnitude (depth) of “dishing” is no larger than 50 nm. It is preferable that (width of the metal-embedded wiring portion)/(magnitude of dishing (depth)) is no less than 3.3×10³ at the time of effecting polishing 1.5 times as long as the time required for standard polishing. This polishing liquid for metal of the present invention is preferably used for a wiring pattern in which the wiring density at the wiring portion is 40 to 60% and each wiring is arranged with a constant interval therebeween.

The present invention further provides a polishing liquid for metal containing a metal-oxidizing agent, an oxidized metal dissolving agent, a protective film forming agent, a water-soluble polymer and water, the polishing liquid being used for producing one of patterns of following (1) and (2):

(1) a pattern in which a metal-embedded wiring portion having width of 100 μm and an insulating film having width of 100 μm are alternately formed; (2) a pattern in which a metal-embedded wiring portion having width of 10 to 100 μm and an insulating film having width of 10 to 100 μm are alternately formed;

the polishing liquid for metal being comprising in that, when a surface to be polished of a metal film embedded in the wiring portion and a surface to be polished of an insulating film formed at both side portions of the metal film is polished substantially flush, wherein (width of the metal-embedded wiring portion)/(magnitude of dishing (depth)) is no less than 10³.

The present invention further provides a polishing liquid for metal containing a metal-oxidizing agent, an oxidized metal dissolving agent, a protective film forming agent, a water-soluble polymer and water, the polishing liquid being used for producing one of patterns of following (1) and (2):

(1) a pattern in which a metal-embedded wiring portion having width of 100 μm and an insulating film having width of 100 μm are alternately formed; (2) a pattern in which a metal-embedded wiring portion having width of 10 to 100 μm and an insulating film having width of 10 to 100 μm are alternately formed;

the polishing liquid for metal being comprising in that, when a surface to be polished of a metal film embedded in the wiring portion and a surface to be polished of an insulating film formed at both side portions of the metal film is polished substantially flush, wherein (width of the metal-embedded wiring portion)/(magnitude of dishing (depth)) is no less than 2×10³ at the time of effecting polishing 1.5 times as long as the time required for standard polishing (i.e. at the time of effecting 50% over-polishing).

The present invention yet further provides a polishing liquid for metal containing a metal-oxidizing agent, an oxidized metal dissolving agent, a protective film forming agent, a water-soluble polymer and water, the polishing liquid being used for producing a wiring pattern having a metal-embedded wiring portion of 1 to 10 μm width and an insulating film portion of 0.1 to 1 μm width in which pattern each wiring portion is arranged with a constant interval therebetween at a wiring density of 70% or higher, comprising in that, when a surface to be polished of a metal film embedded in the wiring portion and a surface to be polished of an insulating film formed at both side portions of the metal film is polished substantially flush, wherein (entire width of the metal-embedded wiring portion)/(magnitude of erosion (depth)) is no less than 0.56×10⁴. Here, it is preferable that the entire width of the metal-embedded wiring portion is 4.5 μm and the magnitude (depth) of “erosion” is no larger than 80 nm. It is preferable that (entire width of the metal-embedded wiring portion)/(magnitude of erosion (depth)) is no less than 1.12×10⁴.

The present invention yet further provides a polishing liquid for metal containing a metal-oxidizing agent, an oxidized metal dissolving agent, a protective film forming agent, a water-soluble polymer and water, the polishing liquid being used for producing a wiring pattern having a metal-embedded wiring portion of 1 to 10 μm width and an insulating film portion of 0.1 to 1 μm width in which pattern each wiring portion is arranged with a constant interval therebetween at a wiring density of 70% or higher, comprising in that, when a surface to be polished of a metal film embedded in the wiring portion and a surface to be polished of an insulating film formed at both side portions of the metal film is polished substantially flush, wherein (entire width of the metal-embedded wiring portion)/(magnitude of erosion (depth)) is no less than 1.12×10⁴ at the time of effecting polishing 1.5 times as long as the time required for standard polishing (i.e. at the time of effecting 50% over-polishing). Here, it is preferable that the entire width of the metal-embedded wiring portion is 4.5 μm and the magnitude (depth) of “erosion” is no larger than 40 nm. It is preferable that (entire width of the metal-embedded wiring portion)/(magnitude of erosion (depth)) is no less than 1.8×10⁴ at the time of effecting polishing 1.5 times as long as the time required for standard polishing.

The present invention further provides a polishing liquid for metal containing a metal-oxidizing agent, an oxidized metal dissolving agent, a protective film forming agent, a water-soluble polymer and water, the polishing liquid being used for producing one of patterns of following (1) and (2):

(1) a pattern in which a metal-embedded wiring portion having width of 4.5 μm and an insulating film having width of 0.5 μm are alternately formed and whose wiring pattern density is 70% or higher; (2) a pattern in which a metal-embedded wiring portion having width of 1 to 10 μm and an insulating film having width of 0.1 to 1 μm are alternately formed and whose wiring pattern density is 70% or higher;

the polishing liquid for metal being comprising in that, when a surface to be polished of a metal film embedded in the wiring portion and a surface to be polished of an insulating film formed at both side portions of the metal film is polished substantially flush, wherein (entire width of the metal-embedded wiring portion)/(magnitude of erosion (depth)) is no less than 0.5625×10⁴.

The present invention further provides a polishing liquid for metal containing a metal-oxidizing agent, an oxidized metal dissolving agent, a protective film forming agent, a water-soluble polymer and water, the polishing liquid being used for producing one of patterns of following (1) and (2):

(1) a pattern in which a metal-embedded wiring portion having width of 4.5 μm and an insulating film having width of 0.5 μm are alternately formed and whose wiring pattern density is 70% or higher; (2) a pattern in which a metal-embedded wiring portion having width of 1 to 10 μm and an insulating film having width of 0.1 to 1 μm are alternately formed and whose wiring pattern density is 70% or higher;

the polishing liquid for metal being comprising in that, when a surface to be polished of a metal film embedded in the wiring portion and a surface to be polished of an insulating film formed at both side portions of the metal film is polished substantially flush, wherein (entire width of the metal-embedded wiring portion)/(magnitude of erosion (depth)) is no less than 1.125×10⁴ at the time of effecting polishing 1.5 times as long as the time required for standard polishing (i.e. at the time of effecting 50% over-polishing)

### EXAMPLES

The present invention will be described further in detail by the following examples hereinafter. It should be noted that the present invention is not restricted by any means to these examples.

(Production of the Polishing Liquid for Metal)

69.6 parts by weight of water was added to 0.15 parts by weight of DL-malic acid (a guaranteed reagent) as an oxidized metal dissolving agent, so that the DL-malic acid was dissolved. 0.2 parts by weight of benzotriazole as a protective film forming agent and 0.05 parts by weight (in the solid state) of pectic acid (molecular weight being 50000) as a water-soluble polymer were added to the solution. Then, 30.0 parts by weight of hydrogen peroxide (aq) (a guaranteed reagent, an aqueous solution of 30 weight %) as a metal-oxidizing agent was added to the mixture, whereby a polishing liquid for metal was obtained. This polishing liquid for metal was used in example 1.

A polishing liquid for metal was prepared in a manner similar to that of example 1, for each of examples 2 to 4 and comparative examples 1 to 3, except that the water-soluble polymer or the protective film forming agent were changed as shown in Table 1. Each polishing liquid for metal obtained in such a manner was then used for examples 2 to 4 and comparative examples 1 to 3. In comparative example 3, a polishing liquid for metal thereof was prepared in a manner similar to that of example 1, except that 1 part by weight of colloidal silica having particle diameter of 100 nm was further added as polishing particles (the content of water was thus reduced to 68.6 parts by weight in comparative example 3). As the colloidal silica, a colloidal silica obtained as a result of hydrolysis of tetraethoxysilane in an aqueous solution of ammonia was used.

### Examples 1 to 4 and Comparative Examples 1 to 3

[Measurement of the CMP Polishing Rate and Cu Etching Rate]

Each of the test substrates 1 to 3 was subjected to CMP by using the aforementioned polishing liquid for metal in the polishing condition described below. The CMP polishing rate (Cu, Ta, SiO₂) and the Cu etching rate observed in each example/comparative example are summarized in Table 1.

Substrate: a silicon substrate on which a copper film having thickness of 1 μm was formed (test substrate 1); a silicon substrate on which a tantalum film having thickness of 200 nm was formed (test substrate 2); and a silicon substrate on which a silicon dioxide film having thickness of 1 μm was formed (test substrate 3).

[Measurement of the Magnitudes of Erosion and Dishing]

A wiring pattern 1 and a wiring pattern 2 were prepared in order to confirm the performance of the aforementioned polishing liquid for metal. Evaluation of performance of each of the prepared polishing solution for metal was carried out according to the evaluation criteria described below. The obtained evaluation results are summarized in Table 2 and Table 3.

-Preparation of the wiring pattern 1—

Preparation of the test substrate 4: A groove having depth of 0.5 μm was formed at a silicon dioxide film having thickness of 1 μm formed on a surface of a silicon substrate. A tantalum film having thickness of 50 nm as a barrier layer was formed, by the known spattering method, on the substrate surface at which the groove had been formed. A copper film having thickness of 1.0 μm was further formed, by the known spattering method, on the substrate at which the tantalum film had been formed. Thereafter, the copper film was embedded in the groove according to the known heat-processing method, whereby the test substrate 4 was obtained.

Next, the aforementioned test substrate 4 was polished in the polishing condition described below, by moving a polishing platen relative to the test substrate 4 in the state in which the test substrate 4 was pressed against a polishing pad stacked on the polishing platen, while the aforementioned polishing liquid for metal was supplied to the polishing pad. A wiring pattern 1 having a stripe-like configuration, in which a wiring metal portion of 100 μm width and an insulating film portion of 100 μm width were alternately arranged, was eventually obtained.

In the polishing process of the test substrate 4 described above, the polishing, until the tantalum layer as a barrier layer formed on silicon dioxide was exposed at the entire surface of the test substrate 4, was regarded as “the first stage polishing (standard polishing)”. The time required for reaching the first stage polishing was defined as “over-polishing 0%” (time), and the polishing effected for a period of time which was 1.5 times as long as the “over-polishing 0%” time was defined as “over-polishing 50%”.

-Preparation of the wiring pattern 2—

A patterned test substrate, in which the depth of the wiring groove was 0.5 μm; the barrier layer was a tantalum film having thickness of 50 nm; and the thickness of the copper film was 1.0 μm, was used as a test substrate (test substrate 5). Next, the aforementioned test substrate 5 was polished in the polishing condition described below, by moving a polishing platen relative to the test substrate 5 in the state in which the test substrate 5 was pressed against a polishing pad stacked on the polishing platen, while the aforementioned polishing liquid for metal was supplied to the polishing pad. A wiring pattern 2 having a stripe-like configuration and entire width of 2.5 mm, in which a wiring metal portion of 4.5 μm width and an insulating film portion of 0.5 μm width were alternately arranged, was eventually obtained.

In the polishing process of the test substrate 4 described above, the polishing, until the tantalum layer as a barrier layer formed on silicon dioxide was exposed at the entire surface of the test substrate 4, was regarded as “the first stage polishing (standard polishing)”. The time required for reaching the first stage polishing was defined as “over-polishing 0%” (time), and the polishing effected for a period of time which was 1.5 times as long as the “over-polishing 0%” time was defined as “over-polishing 50%”.

-Polishing Condition—

Polishing pad: A foamed polyurethane resin (IC1000, manufactured by Rodel inc.) having closed cells

Polishing pressure: 20.6 KPa (210 g/cm²)

Relative speed of the substrate with respect to the polishing platen: 36 m/min

-Evaluation of the Polished Product—

CMP rate: The CMP rate was obtained for each film from the difference in film thickness between and after CMP, which difference in film thickness being converted from the electric resistance.

Etching rate: The etching rate was obtained from the difference in film thickness of the copper layer between and after the immersion of the substrate in the polishing liquid for metal which was being stirred (25° C., the stirring rate being 100 rpm), which difference in film thickness being converted from the electric resistance.

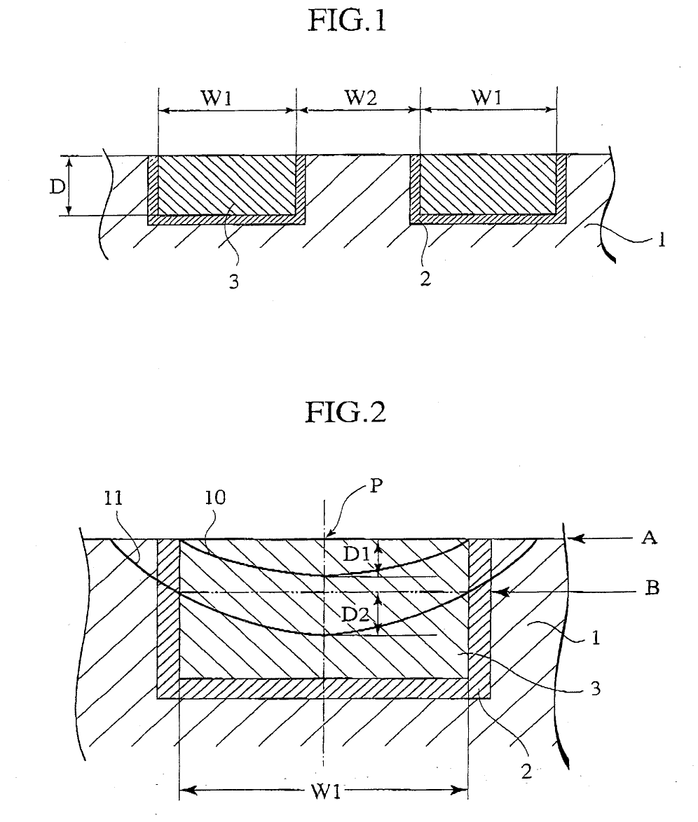

Magnitude of dishing: For the wiring pattern 1 obtained as described above, the magnitude of decrease in film at the wiring metal portion, as compared with the insulating film portion, i.e., the magnitude of “dishing” was obtained, by using a surface profilometer, from the surface configuration of the stripe-like pattern portion in which a wiring metal portion of 100 μm width and an insulating film portion of 100 μm width were alternately arranged. The method of measuring the magnitude of “dishing” is described with reference to FIG. 2 which shows a schematic sectional view of a wiring pattern in which a dishing hole has been formed. As shown in FIG. 2, the dishing hole is formed in a space defined by the imaginary flush surface formed by the insulating film portion 1 and the wiring metal portion 3 (reference plane A) and an downwardly-convexed parabola-like curve 10. When the magnitude of “dishing” was measured, the magnitude of “dishing” was obtained as the depth D1 of the “dish” at the point P which is substantially the center portion of the wiring portion 3, measured from the reference surface A.

In the case in which the “edge” portion of the dishing hole extends beyond the metal wiring portion 3, to the insulating film 1, the magnitude of “dishing” was obtained as the depth D2 of the “dish” defined as the distance between the bottom point of the “dish” and reference plane B, which reference plane B is an imaginary plane positioned in parallel with the reference plane A and passing the two intersections of a downwardly-convexed parabola-like curve 11 and the two ends PB of the metal wiring portion.

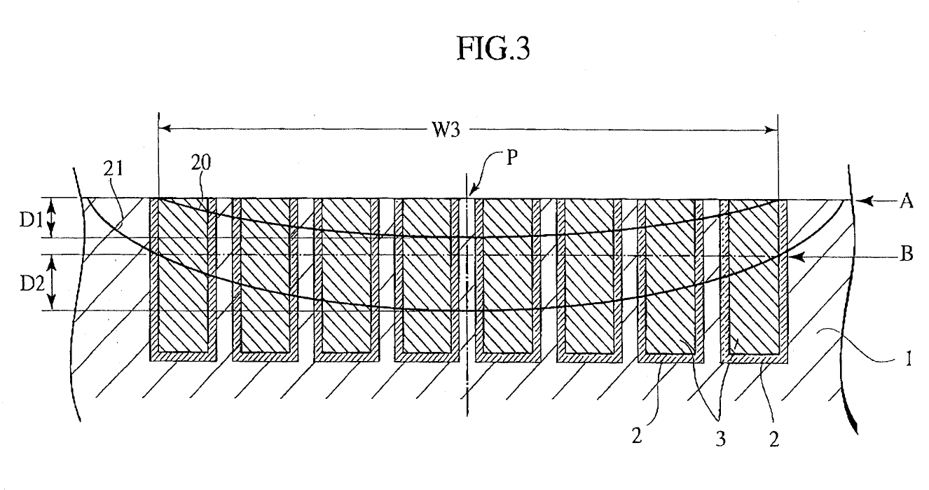

Magnitude of erosion: For the wiring pattern 2 obtained as described above, the magnitude of decrease in film at the insulating film portion in the vicinity of the center of the pattern, as compared with the insulating film field portion in the vicinity of the stripe-like pattern, i.e., the magnitude of “erosion” was obtained by measuring, by using a surface profilometer, the surface configuration of the stripe-like pattern portion having the entire width of 2.5 mm, in which pattern a wiring metal portion of 4.5 μm width and an insulating film portion of 0.5 μm width were alternately arranged. The method of measuring the magnitude of “erosion” is described with reference to FIG. 3 which shows a schematic sectional view of a wiring pattern in which an erosion hole has been formed. As shown in FIG. 3, the erosion hole is formed in a space defined by the imaginary flush surface formed by the insulating film portion 1 and the wiring metal portion 3 (reference plane A) and an downwardly-convexed parabola-like curve 10. When the magnitude of “erosion” was measured, the magnitude of “erosion” was obtained as the depth D1 of the “dish” at the point P which is substantially the center portion of the wiring portion 3, measured from the reference surface A.

In the case in which the “edge” portion of the erosion hole extends beyond the metal wiring portion 3, to the insulating film 1, the magnitude of “erosion” was obtained as the depth D2 of the “dish” defined as the distance between the bottom point of the “dish” and reference plane B, which reference plane B is an imaginary plane positioned in parallel with the reference plane A and passing the two intersections of a downwardly-convexed parabola-like curve 11 and the two ends PB of the metal wiring portion.

Wiring resistance: After completing the first stage polishing of copper, the Ta (tantalum) barrier layer was removed, as the second stage polishing, by using a slurry for the Ta barrier which exhibits sufficiently large ratio of the Ta polishing rate with respect to the polishing rate of other substances (Ta/Cu>1, Ta/SiO₂>50). In the copper wiring pattern of 100 μm width at the portion where the magnitude of “dishing” was measured, the wiring resistance value of the wiring (1 mm) was measured. Additionally, in the copper wiring pattern of 4.5 μm width at the portion where the magnitude of “erosion” was measured, the wiring resistance value of the wiring (1 mm) was measured.

The polishing rate in CMP and the aforementioned polishing rate ratio observed in each of examples 1 to 4 and comparative examples 1 to 3 are shown in Table 1. Further, the magnitudes of “dishing” and “erosion” and the increases thereof (the increases in the magnitudes of “dishing” and “erosion” when the polishing time was increased from “over-polishing 0%” to “over-polishing50%”)observed in the examples/comparative examples are shown in Table 2. The wiring resistance values measured in the examples/comparative examples are shown in Table 3.

TABLE 1

| | Protective | Water-soluble | | | | Polishing | | Cu etching |
|---|---|---|---|---|---|---|---|---|
| | film forming | polymer | CMP polishing rate | | | rate ratio | | rate |
| No. | agent | (molecular weight) | Cu | Ta | SiO₂ | Cu/Ta | Cu/SiO₂ | (nm/min) |
| Example 1 | BTA | Pectic acid | 161.0 | 0.1 | 0.05 | 1610 | 3210 | 1.0 |
| | | (50000) | | | | | | |
| Example 2 | BTA | Polyacrylic | 321.0 | 0.2 | 0.05 | 1605 | 6420 | 0.9 |
| | | acid (25000) | | | | | | |
| Example 3 | BTA | Polyacrylamide | 162.0 | 0.1 | 0.07 | 1620 | 2314 | 1.0 |
| | | (1500) | | | | | | |
| Example 4 | BTA | Polyvinyl | 135.0 | 0.1 | 0.08 | 1350 | 1688 | 0.9 |
| | | alcohol (60000) | | | | | | |
| Comparative | BTA | None | 80.0 | 0.1 | 0.21 | 800 | 381 | 5.5 |
| example 1 | | | | | | | | |
| Comparative | None | None | 145.0 | 0.1 | 0.20 | 1450 | 725 | 60.6 |
| example 2 | | | | | | | | |
| Comparative | BTA | Pectic acid | 205.0 | 15.3 | 14.3 | 13 | 14 | 0.9 |
| example 3 | | (50000) | | | | | | |

TABLE 2

| | Polishing | Example | Example | Example | Example | Comparative | Comparative | Comparative |
|---|---|---|---|---|---|---|---|---|
| | time | 1 | 2 | 3 | 4 | example 1 | example 2 | example 3 |
| Magnitude | Over- | 50 | 70 | 50 | 45 | 105 | 160 | 85 |
| of | polishing 0% | | | | | | | |
| dishing | Over- | 70 | 100 | 70 | 65 | 165 | 230 | 125 |
| (nm) | polishing 50% | (20)* | (30) | (20) | (20) | (60) | (70) | (40) |
| Magnitude | Over- | 20 | 35 | 20 | 20 | 85 | 90 | 100 |
| of | polishing 0% | | | | | | | |
| erosion | Over- | 40 | 65 | 45 | 40 | 135 | 145 | 175 |
| (nm) | polishing 50% | (20*) | (30) | (25) | (20) | (50) | (55) | (75) |

*The number in the parenthesis indicates the increase in magnitude, as compared with the state of “over-polishing 0%”.

TABLE 3

| | Polishing | Example | Example | Example | Example | Comparative | Comparative | Comparative |
|---|---|---|---|---|---|---|---|---|
| | time | 1 | 2 | 3 | 4 | example 1 | example 2 | example 3 |
| Portion at | Over- | 0.360 | 0.376 | 0.362 | 0.356 | 0.410 | 0.476 | 0.390 |
| which dishing | polishing 0% | Ω | Ω | Ω | Ω | Ω | Ω | Ω |
| was evaluated | Over- | 0.376 | 0.406 | 0.378 | 0.372 | 0.484 | 0.602 | 0.432 |
| (100 μm) | polishing 50% | Ω | Ω | Ω | Ω | Ω | Ω | Ω |
| Portion at | Over- | 7.70 | 7.94 | 7.72 | 7.68 | 8.91 | 9.02 | 9.90 |
| which erosion | Polishing 0% | Ω | Ω | Ω | Ω | Ω | Ω | Ω |
| was evaluated | Over- | 8.03 | 8.49 | 8.23 | 8.05 | 10.12 | 10.41 | 11.37 |
| (4.5 μm) | polishing 50% | Ω | Ω | Ω | Ω | Ω | Ω | Ω |

In comparative examples 1 and 2, the polishing rate ratios of copper with respect to tantalum and silicon dioxide are each relatively large. However, in comparative examples 1 and 2, as the etching rate of copper is significantly large, the dishing resistance property and the over-polishing resistance (with regards to dishing) are poor, in particular, and the wiring resistance value was increased. In comparative example 3, as the polishing rates at the tantalum film and the silicon dioxide film are relatively large, the erosion resistance property and the over-polishing resistance (with regards to erosion) are poor, in particular, and the wiring resistance value was increased because of the decrease in wiring thickness.

On the contrary, in examples 1 to 4, the polishing rate ratio of copper with respect to tantalum film (Cu/Ta) and the polishing rate ratio of copper with respect to silicon dioxide film (Cu/SiO₂) are sufficiently large and the etching rate of copper is sufficiently small. Accordingly, the magnitude of “dishing” at the 100 μm wiring was no larger than 70 nm and the increase in “dishing” at the time of “over-polishing 50%” was no larger than 30 nm. Further, the magnitude of “erosion” at the 4.5 μm wiring having wiring density of 90% was no larger than 65 nm and the increase in “erosion” at the time of “over-polishing 50%” was no larger than 30 nm. As a result, it was confirmed that there was relatively little increase, in wiring resistance, which increase was resulted from by the “dishing” and “erosion” characteristics.

The present application is an application based on Japanese patent application 11-323991 (Filing date: Nov. 15, 1999, Publication number: 2001-144048, Date of publication of application: May 25, 2001) and Japanese patent application 11-323992 (Filing date: Nov. 15, 1999, Publication number: 2001-144049, Date of publication of application: May 25, 2001), of which content is incorporated to the present specification by reference.

What is claimed is:

1. A polishing liquid for metal containing a metal-oxidizing agent, an oxidized metal dissolving agent, a protective film forming agent, a water-soluble polymer and water, the polishing liquid being used for producing a wiring pattern having a metal-embedded wiring portion of 10 to 100 μm width and an insulating portion of 10 to 100 μm width in which pattern the wiring portion is arranged at a wiring density of 40 to 60%, the polishing liquid for metal being comprising in that, when a surface to be polished of a metal film embedded in the wiring portion and a surface to be polished of an insulating film formed at both side portions of the metal film is polished substantially flush, wherein (width of the metal-embedded wiring portion)/(magnitude of dishing (depth)) is no less than 10³.

2. A polishing liquid for metal containing a metal-oxidizing agent, an oxidized metal dissolving agent, a protective film forming agent, a water-soluble polymer and water, the polishing liquid being used for producing a wiring pattern having a metal-embedded wiring portion of 10 to 100 μm width and an insulating portion of 10 to 100 μm width in which pattern the wiring portion is arranged at a wiring density of 40 to 60%, the polishing liquid for metal being comprising in that, when a surface to be polished of a metal film embedded in the wiring portion and a surface to be polished of an insulating film formed at both side portions of the metal film is polished substantially flush, wherein (width of the metal-embedded wiring portion)/(magnitude of dishing (depth)) is no less than 2×10³ at the time of effecting polishing 1.5 times as long as the time required for standard polishing.

3. A polishing liquid for metal according to claim 1, wherein the water-soluble polymer is at least one type of water-soluble polymer whose weight average molecular weight is 500 or more.

4. A polishing liquid for metal according to claim 1, wherein the water-soluble polymer is at least one type of water-soluble polymer selected from the group consisting of polysaccharide, polycarboxylic acid, ester of polycarboxylic acid, salt of polycarboxylic acid and vinyl-based polymer.

5. A polishing liquid for metal according to claim 1, wherein the metal-oxidizing agent is at least one type of substance selected from the group consisting of hydrogen peroxide, nitric acid, potassium periodate, hypochlorous acid and ozone (aq).

6. A polishing liquid for metal according to claim 1, wherein the oxidized metal dissolving agent is at least one type of substance selected from the group consisting of organic acid, ester of organic acid, ammonium salt of organic acid and sulfuric acid.

7. A polishing liquid for metal according to claim 1, wherein the protective film forming agent is at least one type of substance selected from the group consisting of a nitrogen-containing compound and a salt thereof, mercaptan, glucose and cellulose.

8. A polishing liquid for metal according to claim 1, wherein the metal film to be polished contains at least one type of substance selected from the group consisting of copper, copper alloy and oxides thereof.

9. A polishing liquid for metal according to claim 1, wherein a barrier layer is provided beneath the metal to be polished and the barrier layer is formed of a substance selected from the group consisting of tantalum, tantalum nitride, tantalum alloy and tantalum compounds of other types.

10. A polishing liquid for metal containing a metal-oxidizing agent, an oxidized metal dissolving agent, a protective film forming agent, a water-soluble polymer and water, the polishing liquid being used for producing a wiring pattern having a metal-embedded wiring portion of 10 to 100 μm width and an insulating portion of 10 to 100 μm width in which pattern the wiring portion is arranged at a wiring density of 40 to 60%, the polishing liquid for metal being comprising in that, when a surface to be polished of a metal film embedded in the wiring portion and a surface to be polished of an insulating film formed at both side portions of the metal film is polished substantially flush, wherein (width of the metal-embedded wiring portion)/(magnitude of dishing (depth)) is no less than 2×10³.

11. A polishing liquid for metal containing a metal-oxidizing agent, an oxidized metal dissolving agent, a protective film forming agent, a water-soluble polymer and water, the polishing liquid being used for producing a wiring pattern having a metal-embedded wiring portion of 10 to 100 μm width and an insulating portion of 10 to 100 μm width in which pattern the wiring portion is arranged at a wiring density of 40 to 60%, the polishing liquid for metal being comprising in that, when a surface to be polished of a metal film embedded in the wiring portion and a surface to be polished of an insulating film formed at both side portions of the metal film is polished substantially flush, wherein (width of the metal-embedded wiring portion)/(magnitude of dishing (depth)) is no less than 3.3×10³ at the time of effecting polishing 1.5 times as long as the time required for standard polishing.

12. A polishing method, wherein a film to be polished, of a substrate, is polished by moving a polishing platen relative to the substrate in the state in which the film to be polished of the substrate is pressed against a polishing pad stacked on the polishing platen, while the polishing liquid for metal of claim 1 is supplied to the polishing pad.

13. A polishing liquid for metal containing a metal-oxidizing agent, an oxidized metal dissolving agent, a protective film forming agent, a water-soluble polymer and water, the polishing liquid being used for producing a wiring pattern having a metal-embedded wiring portion of 1 to 10 μm width and an insulating film portion of 0.1 to 1 μm width in which pattern each wiring portion is arranged with a constant interval therebetween at a wiring density of 70% or higher, comprising in that, when a surface to be polished of a metal film embedded in the wiring portion and a surface to be polished of an insulating film formed at both side portions of the metal film is polished substantially flush, wherein (entire width of the metal-embedded wiring portion)/(magnitude of erosion (depth)) is no less than 0.56×10⁴.

14. A polishing liquid for metal containing a metal-oxidizing agent, an oxidized metal dissolving agent, a protective film forming agent, a water-soluble polymer and water, the polishing liquid being used for producing a wiring pattern having a metal-embedded wiring portion of 1 to 10 μm width and an insulating film portion of 0.1 to 1 μm width in which pattern each wiring portion is arranged with a constant interval therebetween at a wiring density of 70% or higher, comprising in that, when a surface to be polished of a metal film embedded in the wiring portion and a surface to be polished of an insulating film formed at both side portions of the metal film is polished substantially flush, wherein (entire width of the metal-embedded wiring portion)/(magnitude of erosion (depth)) is no less than 1.12×10⁴ at the time of effecting polishing 1.5 times as long as the time required for standard polishing.

15. A polishing liquid for metal according to claim 13, wherein the water-soluble polymer is at least one type of water-soluble polymer whose weight average molecular weight is 500 or more.

16. A polishing liquid for metal according to claim 13, wherein the water-soluble polymer is at least one type of water-soluble polymer selected from the group consisting of polysaccharide, polycarboxylic acid, ester of polycarboxylic acid, salt of polycarboxylic acid and vinyl-based polymer.

17. A polishing liquid for metal according to claim 13, wherein the metal-oxidizing agent is at least one type of substance selected from the group consisting of hydrogen peroxide, nitric acid, potassium periodate, hypochlorous acid and ozone (aq).

18. A polishing liquid for metal according to claim 13, wherein the oxidized metal dissolving agent is at least one type of substance selected from the group consisting of organic acid, ester of organic acid, ammonium salt of organic acid and sulfuric acid.

19. A polishing liquid for metal according to claim 13, wherein the protective film forming agent is at least one type of substance selected from the group consisting of a nitrogen-containing compound and a salt thereof, mercaptan, glucose and cellulose.

20. A polishing liquid for metal according to claim 13, wherein the metal film to be polished contains at least one type of substance selected from the group consisting of copper, copper alloy and oxides thereof.

21. A polishing liquid for metal according to claim 13, wherein a barrier layer is provided beneath the metal to be polished and the barrier layer is formed of a substance selected from the group consisting of tantalum, tantalum nitride, tantalum alloy and tantalum compounds of other types.

22. A polishing liquid for metal containing a metal-oxidizing agent, an oxidized metal dissolving agent, a protective film forming agent, a water-soluble polymer and water, the polishing liquid being used for producing a wiring pattern having a metal-embedded wiring portion of 1 to 10 μm width and an insulating film portion of 0.1 to 1 μm width in which pattern each wiring portion is arranged with a constant interval therebetween at a wiring density of 70% or higher, comprising in that, when a surface to be polished of a metal film embedded in the wiring portion and a surface to be polished of an insulating film formed at both side portions of the metal film is polished substantially flush, wherein (entire width of the metal-embedded wiring portion)/(magnitude of erosion (depth)) is no less than 1.12×10⁴.

23. A polishing liquid for metal containing a metal-oxidizing agent, an oxidized metal dissolving agent, a protective film forming agent, a water-soluble polymer and water, the polishing liquid being used for producing a wiring pattern having a metal-embedded wiring portion of 1 to 10 μm width and an insulating film portion of 0.1 to 1 μm width in which pattern each wiring portion is arranged with a constant interval therebetween at a wiring density of 70% or higher, comprising in that, when a surface to be polished of a metal film embedded in the wiring portion and a surface to be polished of an insulating film formed at both side portions of the metal film is polished substantially flush, wherein (entire width of the metal-embedded wiring portion)/(magnitude of erosion (depth)) is no less than 1.8×10⁴ at the time of effecting polishing 1.5 times as long as the time required for standard polishing.

24. A polishing method, wherein in that a film to be polished, of a substrate, is polished by moving a polishing platen relative to the substrate in the state in which the film to be polished of the substrate is pressed against a polishing pad stacked on the polishing platen, while the polishing liquid for metal of claim 13 is supplied to the polishing pad.
